(19) United States
(12) Patent Application Publication
(10) Pub. No.: US 2006/0114225 A1
(43) Pub. Date: Jun. 1, 2006

(54) Cursor function switching method

(76) Inventors: Yujin Tsukada, Saitama (JP); Takeshi Hoshino, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/288,208

(22) Filed: Nov. 29, 2005

(30) Foreign Application Priority Data
Nov. 30, 2004 (JP) 2004-346130

(51) Int. Cl. G09G 5/08

(52) U.S. Cl. 345/157

(57) ABSTRACT

A hand-shaped cursor showing a scrolling function is displayed on the display screen of the information processing device in a state where a wheel is not operated. When a user rotates the wheel to change a cursor function, the cursor on the display screen is changed to an arrow cursor indicating a selecting function. Then, when the user presses down the wheel, the cursor displayed on the screen selects an object on the screen pointed at by the cursor.

The present application claims priority from Japanese application JP2004-346130 filed on Nov. 30, 2004, the content of which is hereby incorporated by reference into this application.

### BACKGROUND OF THE INVENTION

The present invention relates to a cursor function switching method and an information processing device using the same. More specifically, the invention relates to the cursor function switching method and the information processing device using the same in which by selecting the function of a cursor in the information processing device, an operation using cursor functions can be easily performed. In the information processing device, the cursor to be controlled by a pointing device is displayed on a display screen thereof, and operation processing is thereby performed.

Generally, in a graphic user interface (GUI) in the information processing device such as a personal computer (PC), a mouse, a touch pad, or the like is employed as a pointing device to display the cursor (pointer) on the display screen. In the pointing device, the cursor is displayed and moved to a certain position on the display screen of the information processing device to select a text character at that position, or to use the address of a home page on the Internet displayed at that position, thereby making access to the home page. In order to change the function of the cursor in the common GUI, some techniques such as the change using rollover and the change using a tool palette are known. In the change using the rollover, when the cursor rolls over an object, the function of the cursor changes to the function according to the object. Usually, these techniques are combined, thereby making it possible to bring about a change in the cursor function needed by a user. In this method of combining these techniques, in order to determine the position of pointing, the user uses clicking alone as a physical operation. By changing the cursor function, however, the user can execute various commands.

As prior arts about the methods of using the pointing device, three techniques, for example, are known. The first one is the technique disclosed in JP-A-2002-82770, in which switching between the mouse and the touch pad is performed, for use. The second one is the technique disclosed in JP-A-2002-323945. In this technique, whether a hand touches a mouse pointer or not is recognized by the touch pad, and control is performed so that a menu or a help facility is displayed only while the hand touches the mouse pointer, and the menu or the help facility disappears when the hand is detached from the mouse pointer. Status information, a control function, information on a help text and the like can be thereby provided to the user. The third one is the technique disclosed in JP-A-10-3352. The touch pad is provided in place of a mouse button, and behavior at the time of clicking is changed according to the pressure of a finger that presses down the touch pad.

The prior arts described above, however, have no interaction for intuitively selecting a frequently used cursor function, and are therefore inadequate as the methods of selecting the frequently used cursor function.

Now, by giving attention to movement of a human hand when work is actually performed using the PC or the like, this problem will be described.

Generally, the human hand has ability to variously change its shape according to the context and target of the work. Humans can perform operations such as pointing to a specific location of a document on a disk, turning a page of the document on the disk, or moving the document while pressing the document against the desk, by changing the shape of the hand. The thought process of the humans at the time of changing the shape of the hand is an intuitive process in which the hand changes to a desired shape at the instant when an operation desired to be performed on an object has been determined. It is not the process in which one of tools for performing the operation on the object is selected.

When the PC is operated, the cursor on the display screen may be considered to be an extension of the human hand. Accordingly, a desire is generated in the user, in which by changing the cursor function as intuitively as with the hand, some cursor functions can be implemented. On contrast therewith, by the change in the cursor function using the rollover described above only one cursor function can be implemented. Thus, in some cases, the user cannot select a desired cursor function. One of the cases, for example, is the one in which although the user desires to select part of a text within a hypertext, the cursor function is automatically changed to the function of jumping to the destination of a link.

As a method of selecting the desired cursor function at the user's decision, the tool palette or a context menu are provided. The thought process for cursor function selection using this tool or menu is a flow in which selectable tools or menus are viewed and a target tool or menu is selected from among them. This flow is different from the thought process described above when the shape of the hand is changed. More specifically, in this method, when a frequently used tool is selected in such a manner as is performer by the user's hand, it sometimes happens that the process does not match the process expected by the user, so that the process is felt to be bothering.

Further, as a method of more directly selecting the desired cursor function, selection by modifier keys of a keyboard or selection by option buttons of the pointing device is provided. These selections have problems as follows.

In the selection by the modifier keys, relationships between the keys and the cursor functions must be learned. Thus, a barrier for being skilled in the selection is high. Further, since the hand different from the hand that holds the pointing device must be used, the selection by the modifier keys is not so intuitive.

For the selection by the option buttons of the pointing device, there are provided a method of assigning cursor functions to the option buttons of the pointing device and a method of performing cursor function switching by pressing down an option button of the pointing device. In the cursor function assigning method (using the panning function of a center button in a Kensington Studio Mouse [1], for example), relationships between the buttons and the cursor functions must be learned as in the case of the modifier keys. Further, unless the option buttons are pressed down, the functions assigned to the buttons, respectively, cannot be known. Accordingly, an erroneous operation of selecting an unintended cursor function and pressing down the option button corresponding to the unintended cursor function tends to occur.

In the switching method of the cursor functions (such as the scroll direction and speed control function of the wheel button of a Microsoft Wheel Mouse [2]) by pressing down the option button of the pointing device, it must take the trouble to press down one of the option buttons in order to perform the cursor function switching. Thus, pressing down the one of the option buttons is felt to be bothering. Further, the “cursor function switching” and “function execution (clicking)” are both performed by pressing down the buttons on the pointing device. Thus, confusion tends to be brought about.

### SUMMARY OF THE INVENTION

An object of the present invention is therefore to solve the problems of the prior arts described above and to provide a cursor function switching method and an information processing device using the same in which by enabling intuitive and easy selection of the function of a cursor in the information processing device, an operation using the cursor can be readily performed. In the information processing device, the cursor to be controlled by a pointing device is displayed on a display screen thereof, and operation processing is thereby performed.

The object of the present invention is achieved by a cursor function switching method in an information processing device, the information processing device displaying on a display screen thereof a cursor to be controlled by a pointing device, thereby performing operation processing, wherein

the information processing device receives a signal from cursor function selecting means of the pointing device and assigns a function corresponding to the received signal to the cursor and changes the displayed shape of the cursor to a shape indicating the function.

Alternatively, the object of the present invention is achieved by an information processing device that displays on a display screen thereof a cursor to be controlled by a pointing device, thereby performing operation processing, wherein

the pointing device includes a cursor function selecting unit; and

the information processing device includes:

a unit for receiving a signal from the cursor function selecting unit of the pointing device and assigning a function corresponding to the received signal to the cursor; and

a unit for changing the shape of the displayed cursor to a shape indicating the assigned function.

According to the present invention, in the information processing device that displays on the display screen thereof the cursor to be controlled by the pointing device, thereby performing operation processing, intuitive and easy selection of the cursor function from among cursor functions can be performed, so that an operation using these cursor functions can be readily performed.

Other objects, features and advantages of the invention will become apparent from the following description of the embodiments of the invention taken in conjunction with the accompanying drawings.

### BRIEF DESCRIPTION OF THE DRAWINGS

FIG. 1A is a block diagram showing a hardware configuration of an information processing device according to an embodiment of the present invention, in which a pointing device with wheel is employed;

FIG. 1B is a block diagram showing a hardware configuration of an information processing device according to the embodiment of the present invention, in which a pointing device with touch sensor is employed;

FIG. 2A is a diagram for explaining an operation example and change in screen when the pointing device with wheel is employed;

FIG. 2B is a diagram for explaining an operation example and change in screen when the pointing device with wheel is employed;

FIG. 2C is a diagram for explaining an operation example and change in screen when the pointing device with wheel is employed;

FIG. 3A is a diagram for explaining an operation example and change in screen when a pointing device with slider switch is employed;

FIG. 3B is a diagram for explaining an operation example and change in screen when the pointing device with slider switch is employed;

FIG. 3C is a diagram for explaining an operation example and change in screen when the pointing device with slider switch is employed;

FIG. 4A is a diagram for explaining an operation example and change in screen when the pointing device with touch sensor is employed;

FIG. 4B is a diagram for explaining an operation example and change in screen when the pointing device with touch sensor is employed;

FIG. 4C is a diagram for explaining an operation example and change in screen when the pointing device with touch sensor is employed;

FIG. 5A is a diagram showing cursor function arrangement when the pointing device with wheel described with reference to FIGS. 2A, 2B, and 2C is employed;

FIG. 5B is a flowchart explaining a processing operation of the information processing device when the pointing device with wheel is employed;

FIG. 6A is a diagram showing cursor function arrangement when the pointing device with touch sensor described with reference to FIGS. 4A, 4B, and 4C is employed;

FIG. 6B is a flowchart showing a processing operation of the information processing device when the pointing device with touch sensor is employed;

FIG. 7A is a diagram showing cursor function arrangement when the pointing device with wheel is operated;

FIG. 7B is a diagram for specifically explaining changes in the cursor function in processing when the pointing device with wheel is operated, described in FIGS. 5A and 5B;

FIG. 7C is a diagram for specifically explaining changes in the cursor function in the processing when the pointing device with wheel is operated;

FIG. 8A is a diagram showing an operation example when the embodiment of the present invention is used in conjunction with a tool palette;

FIG. 8B is a diagram showing the operation example when the embodiment of the present invention is used in conjunction with the tool palette;

FIG. 8C is a diagram showing the operation example when the embodiment of the present invention is used in conjunction with the tool palette;

FIG. 9A is a diagram for explaining an application example in which the embodiment of the present invention is used for expansion of a hit area;

FIG. 9B is a diagram for explaining the application example in which the embodiment of the present invention is used for expansion of the hit area;

FIG. 9C is a diagram for explaining the application example in which the embodiment of the present invention is used for expansion of the hit area;

FIG. 9D is a diagram for explaining the application example in which the embodiment of the present invention is used for expansion of the hit area;

FIG. 10 is a diagram for explaining display of cursor alternatives;

FIG. 11A is a diagram for explaining an example of a case where the present invention is applied to a pointing device of a notebook PC;

FIG. 11B is a diagram for explaining the example of the case where the present invention is applied to the pointing device of the notebook PC;

FIG. 11C is a diagram for explaining the example of the case where the present invention is applied to the pointing device of the notebook PC;

FIG. 11D is a diagram for explaining the example of the case where the present invention is applied to the pointing device of the notebook PC;

FIG. 12A is a diagram explaining other shape of the pointing device with touch sensor;

FIG. 12B is a diagram explaining other shape of the pointing device with touch sensor; and

FIG. 12C is a diagram explaining other shape of the pointing device with touch sensor.

### DESCRIPTION OF THE EMBODIMENTS

An embodiment of a cursor function switching method and an information processing device using the same according to the present invention will be described below in detail with reference to drawings.

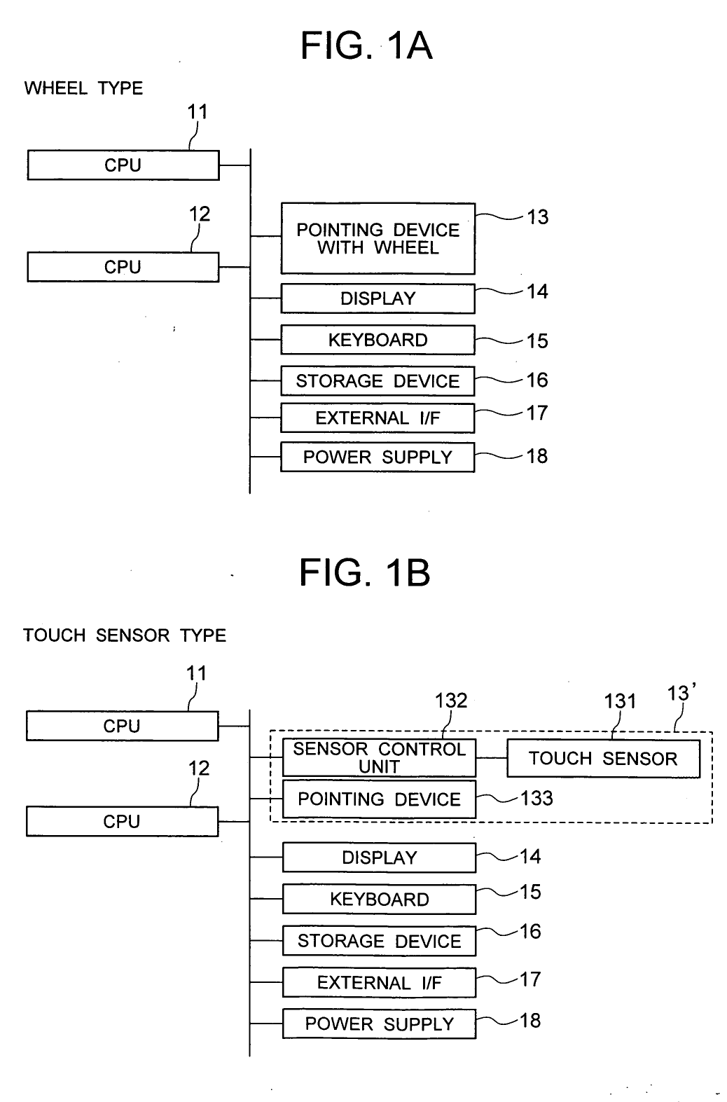

FIGS. 1A and 1B are block diagrams respectively showing hardware configurations of information processing devices according to the embodiment of the present invention. In FIGS. 1A and 1B, reference numeral 1 denotes a CPU, 12 is a memory, 13 is a pointing device with wheel or 13′ is alternative pointing device such as a pointing device with touch sensor, 14 is a display, 15 is a keyboard, 16 is a storage device, 17 is an external interface (I/F), 131 is a touch sensor, 132 is a sensor control unit, and 133 denotes a pointing device.

The information processing device shown in FIG. 1A in the embodiment of the present invention is an example in which the pointing device (mouse) with wheel is employed as the pointing device. This information processing device is constituted from the CPU 11 for performing various processing, the memory 12 for storing various data and the like, for use for processing executed by the CPU 11, the pointing device 13 with wheel using a mouse constituted from two buttons and the wheel provided between the two buttons, the display 14 such as a cathode ray tube (CRT), a liquid crystal display (LCD), or the like, the keyboard 15 for performing text input, the storage device 16 constituted from a hard disk and the like, the external I/F 17 for receiving information from and supplying information to an external device, and the power supply unit 18 for supplying power to the overall information processing device.

In the information processing device shown in FIG. 1B, in place of the pointing device 13 with wheel used in the information processing device shown in FIG. 1A, the pointing device (mouse) 13′ with touch sensor is used. Other configurations are the same as those shown in FIG. 1A. The pointing device 13′ with touch sensor is constituted from the touch sensor 131 provided on the upper surface of the mouse commonly used, for detecting touch of a finger, sensor control unit 132, and pointing device 133 such as the mouse. Configurations such as the shapes of this pointing device 13′ with touch sensor and the like will be described later.

Since the information processing devices shown in FIGS. 1A and 1B are the well-known information processing devices represented by PC etc., their detailed descriptions will be omitted herein.

Next, operations of the pointing devices that perform the method according to the embodiment of the present invention will be described. Before that, an outline of the cursor function switching method according to the embodiment of the present invention will be first described.

In the embodiment of the present invention, in order to intuitively change a cursor function as in the case of a user's own hand, a unit for making selection among a plurality of cursor functions through movement of a finger is provided on (or in the vicinity of) a click button of the pointing device such as the mouse, thereby enabling clicking immediately after a desired cursor function has been selected. Further, when the cursor function is changed by the selection unit on the pointing device, the change in the cursor function is reflected on display of a cursor on the display screen of the information processing device. Accordingly, before the clicking, it can be seen which cursor function a user has selected.

By the unit for selecting the cursor function described above, the user can select the cursor function as he desires with the finger of his hand that holds the pointing device. Differing from a case where a context menu or the like is employed, this selection is closer to a feeling of directly selecting a “usually used cursor function” felt by the tip of the finger rather than selection of the cursor function among a plurality of alternatives. Further, the selection unit is on (or in the vicinity of) the click button, selection of the cursor function and execution of the cursor function (clicking) are not performed separately: the execution of the cursor function can be performed almost simultaneously with the selection of the cursor function. Such an interaction may be close to the action of the “human hand” that will change its shape so that it can easily hold an object almost at the same instant when the “human hand” holds the object.

When only the unit for selecting the cursor function described above is provided, however, the user cannot select the desired cursor function unless he learns relationships between finger movements and cursor functions. Thus, in the embodiment of the present invention, when the cursor function is changed by the selection unit on the pointing device, the change is reflected on the cursor display on the display screen. The result of the cursor function selection can be thereby informed to the user before clicking. Thus, even if the user is not used to the operation of the cursor function selection, the user can perform the operation of the selection with reliability. Further, since the user can see the cursor that changes corresponding to the movement of his finger, he can learn the relationships between the finger movements and the cursor functions while he uses the cursor functions. He can therefore pass through the natural process of gradually learning frequently used cursor functions.

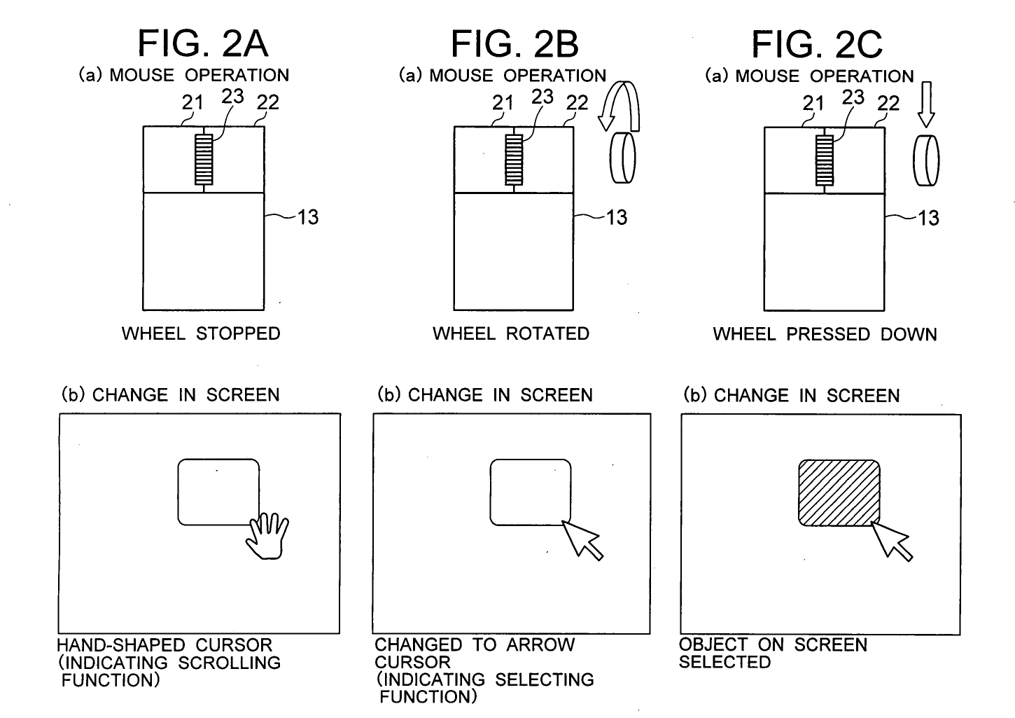

FIGS. 2A, 2B, and 2C are diagrams explaining an operation example when the pointing device 13 with wheel is used. Next, the operation example of the pointing device with wheel will be described. Referring to FIGS. 2A, 2B, and 2C, the pointing device with wheel 13 includes a left-clicking button 21, a right-clicking button 22, and a wheel 23.

The pointing device with wheel 13 shown in FIGS. 2A, 2B, and 2C is a so-called mouse with wheel, and has a precisely identical hardware configuration to that of a commonly used mouse. The pointing device 13 with wheel is constituted from the left-clicking button 21, right-clicking button 22, and wheel 23 provided between these click buttons.

Now, it is assumed that a hand-shaped cursor showing a scrolling function as shown in (b) of FIG. 2A is displayed on the display screen of the information processing device in a state in which the wheel 23 is not operated, as shown in (a) of FIG. 2A. Then, when the user rotates the wheel 23 to change the cursor function as shown in (a) of FIG. 2B, the cursor on the display screen changes to an arrow cursor showing a selecting function as shown in (b) of FIG. 2B, for example. Then, when the user presses down the wheel 23 as shown in (a) of FIG. 2C, the cursor displayed on the display screen selects the object on the display screen pointed at by the cursor, as shown in (b) of FIG. 2C.

In the example described with reference to FIGS. 2A, 2B, and 2C, it was described that rotation of the wheel switches one cursor function to other cursor function. In the present invention, a lot of cursor functions are assigned according to the rotation of the wheel 23, and the shape of the cursor can be sequentially changed on the display screen, corresponding to the functions of the cursor, for display. Then, when the direction of the rotation is reversed, the direction of the change is reversed, so that the display of the cursor is changed. In the example described above, by pressing down the wheel 23, the same functions as those of the left-clicking button are performed. Instead of pressing down the wheel 23, the left-clicking button 21 may be pressed.

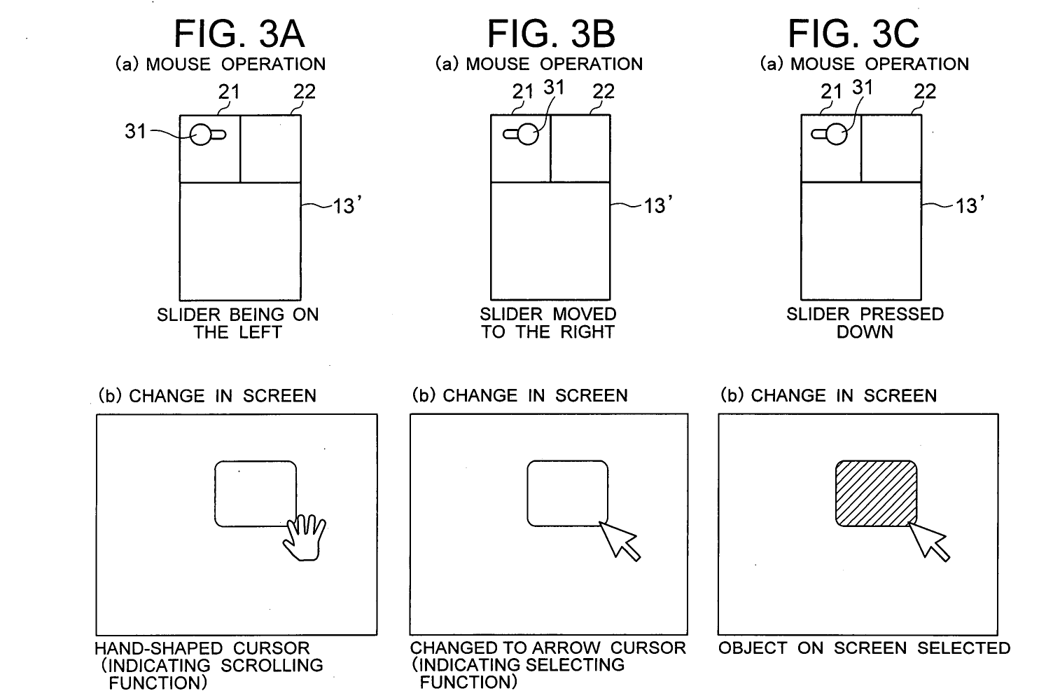

FIGS. 3A, 3B, and 3C are diagrams explaining an operation example in which the pointing device 13′ with slider switch is employed. Next, the operation example of the pointing device 13′ with slider switch will be described. Referring to FIGS. 3A, 3B, and 3C, reference numeral 31 denotes the slider switch, and other reference numerals are the same as those in FIGS. 2A, 2B, and 2C.

The pointing device 13′ with slider switch shown in FIGS. 3A, 3B, and 3C is the mouse having the left-clicking button 21 and the right-clicking button 22. The slider switch 31 is provided on the left-clicking button 21 according to the present invention. In the example shown in FIGS. 3A, 3B, and 3C, the pointing device 13′ with slider switch is shown as the mouse without wheel. The wheel may be provided between the left-clicking button 21 and the right-clicking button 22.

Now, it is assumed that the hand-shaped cursor showing the scrolling function as shown in (b) of FIG. 3A is displayed on the display screen of the information processing device with the slider switch 31 located on the left side of the pointing device 13′ with slider switch, as shown in (a) of FIG. 3A. Then, when the user slides the slider switch 31 to the right as shown in (a) of FIG. 3B in order to change the cursor function, the cursor on the display screen is changed to the arrow cursor showing the selecting function, as shown in (b) of FIG. 3B, for example. Then, when the user presses down the slider switch 31 as shown in (a) of FIG. 3, the left-clicking button 21 is also pressed down, and the cursor displayed on the display screen selects the object on the display screen pointed at by the cursor, as shown in (b) of FIG. 3C.

In the example described in FIGS. 3A, 3B, and 3C, it was described that use of two right and left positions of the slider switch 31 switches one cursor function to other cursor function. In the present invention, a plurality of positions can be set for the slider switch 31, and one cursor function is assigned to each of the positions. Then, the shape of the cursor can be sequentially changed on the display screen, corresponding to each cursor function, for display.

In the method described above with reference to FIGS. 3A, 3B, and 3C, the positions of the slider switch 31 are associated with specific cursor functions. Accordingly, when the relationships between the positions of the slider switch 31 and the specific cursor functions are grasped, selection of the cursor function can be more directly performed than in the case where the wheel is used. On the other hand, the number of the cursor functions that can be selected is limited by the relationship between the length of the slider switch and the size of the finger.

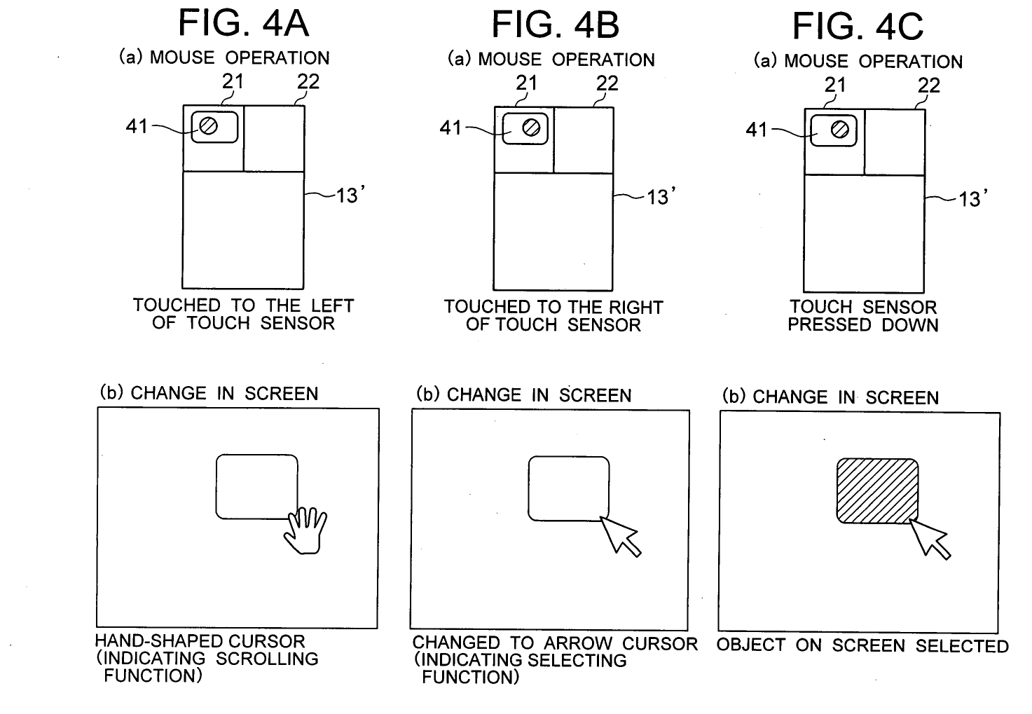

FIGS. 4A, 4B, and 4C are diagrams explaining an operation example in which the pointing device 13′ with touch sensor is employed. Next, the operation example of the pointing device 13′ with touch sensor will be described. Referring to FIGS. 4A, 4B, and 4C, reference numeral 41 denotes a touch sensor, and other reference numerals are the same as those in FIGS. 2A, 2B, and 2C. Referring to FIGS. 4A, 4B, and 4C, a circle indicated by oblique lines shows the finger that has touched the circle.

The pointing device with slider switch 13′ shown in FIGS. 4A, 4B, and 4C is the mouse having the left-clicking button 21 and the right-clicking button 22. The touch sensor 41 is provided on the left-clicking button 21 according to the present invention. In the example shown in FIGS. 4A, 4B, and 4C, the pointing device with touch sensor 13′ is shown as the mouse without wheel. However, the wheel may be provided between the left-clicking button 21 and the right-clicking button 22.

Now, it is assumed that the hand-shaped cursor showing the scrolling function as shown in (b) of FIG. 4A is displayed on the display screen of the information processing device with the finger of the user touching the left side of the touch sensor 41, as shown in (a) of FIG. 4A. Then, when the user touches his finger on the right side of the touch sensor 41 in order to change the cursor function, as shown in (a) of FIG. 4B, the cursor on the display screen is changed to the arrow cursor showing the selecting function as shown in (b) of FIG. 4B, for example. Then, when the user presses down the slider switch 41 as shown in (a) of FIG. 4C, the left-clicking button 21 is also pressed down, and the cursor displayed on the display screen selects the object on the display screen pointed at by the cursor, as shown in (b) of FIG. 4C.

The touch sensor 41 can be moved with the finger touched thereon, and selection of the cursor function can also be performed by this movement. With this arrangement, the same function as that of the wheel described with reference to FIGS. 2A, 2B, and 2C can be executed.

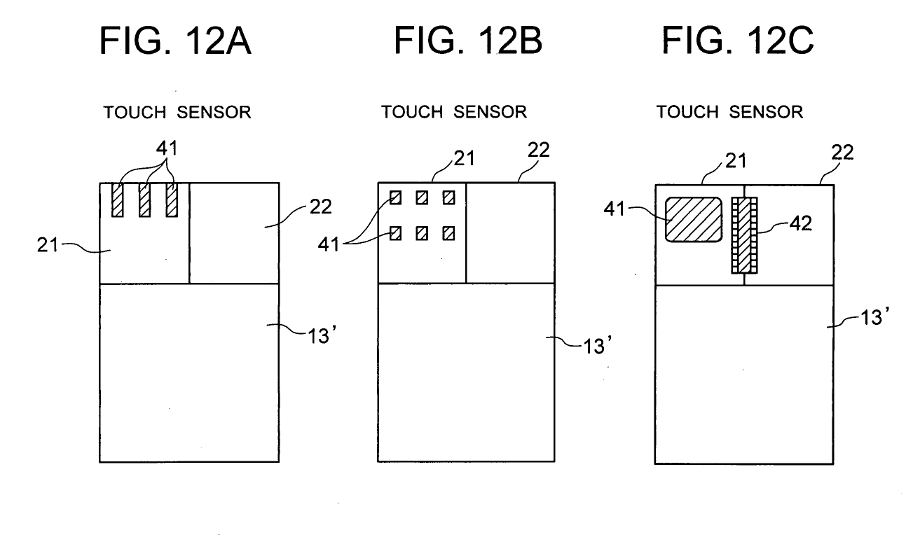

FIGS. 12A, 12B, and 12C show diagrams explaining other shapes of the pointing device with touch sensor. Next, variation examples of the pointing device with touch sensor described with reference to FIGS. 4A, 4B, and 4C will be described. Referring to FIG. 12C, reference numeral 42 is the touch sensor provided on the wheel. Other reference numerals are the same as those in FIGS. 4A, 4B, and 4C.

In the pointing devices with touch sensors 13′ in FIG. 12A and FIG. 12B, a plurality of the independent touch sensors 41 are provided in respective reacting positions of the left-clicking button 21. In the example shown in FIG. 12A, three touch sensors 41 are arranged in parallel to each other. In the example shown in FIG. 12B, six touch sensors 41 are divided into two rows, and three of the six touch sensors 41 are arranged in each row. For each of these touch sensors 41 independently provided in the respective reacting positions, a protrusion can also be provided so that when the finger touches the protrusion, it can be seen which reacting position is touched. Even when the pointing device 13′ of the configuration described above is employed, the desired cursor function can be selected, for operation, as described in FIGS. 4A, 4B, and 4C.

In the pointing device with touch sensor 13′ shown in FIG. 12C, the touch sensor 42 is provided on the upper surface of the wheel of the mouse with wheel as well. The touch sensor 41 provided for the left-clicking button 21 may be the same as those described by illustration in FIGS. 4A, 4B, 4C, 12A, and 12B. In the example shown in this FIG. 12C, different cursor functions are assigned to the touch sensor 41 provided for the left-clicking button 21 and the touch sensor 42 provided on the upper surface of the wheel, respectively. When the finger touches the touch sensor 42 provided on the upper surface of the wheel, the cursor function is immediately switched to the function assigned to the touch sensor 42, and the cursor display is also changed to the shape showing that function.

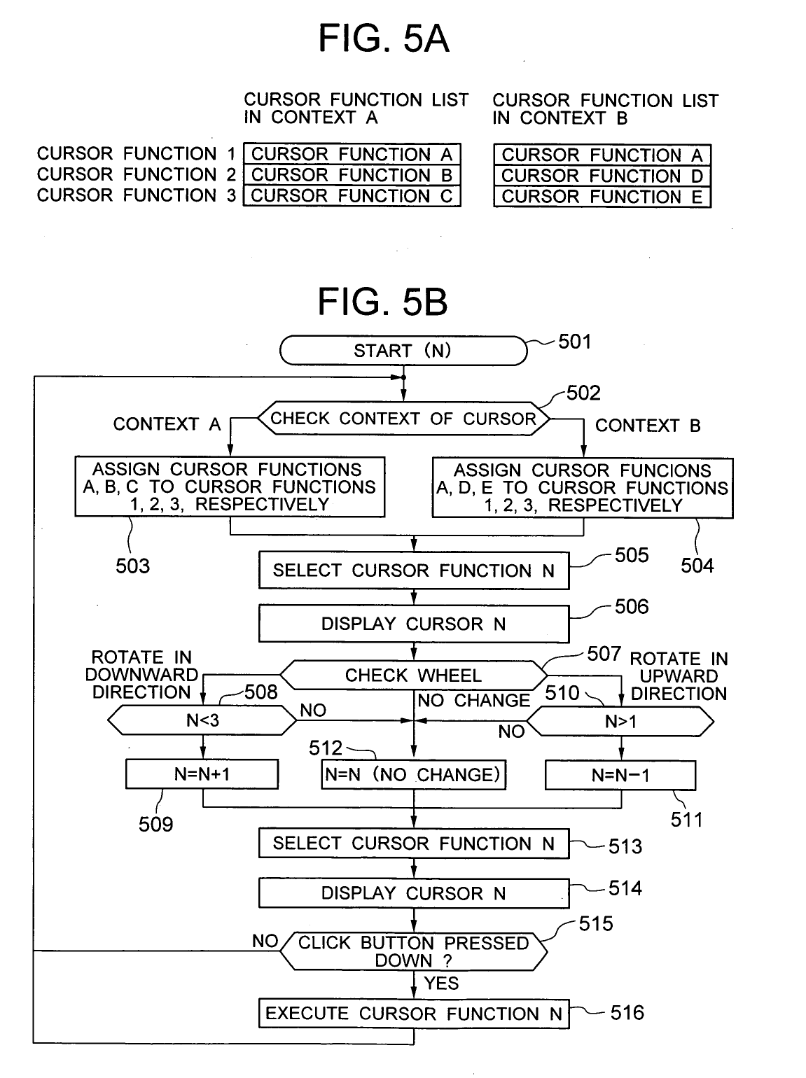

FIG. 5A is a diagram showing cursor function arrangement when the pointing device with wheel (hereinafter referred to just as the mouse) described with reference to FIGS. 2A, 2B, and 2C is employed.

FIG. 5B is a flowchart explaining a processing operation of the information processing device when the pointing device with wheel is employed. Next, the processing operation will be described.

Generally, the cursor function that can be performed is determined by the status of a location of the display screen in which the cursor is positioned, or an object in that location. A combination of the object and the cursor function described above is referred to as a context. In an example of processing described in the flowchart shown in FIG. 5B, it is assumed that there are two types of contexts A and B. It is also assumed that there are three cursor functions 1 to 3 that can be selected according to the rotation of the wheel. According to the rotation of the wheel in a downward direction (toward the user), the cursor function is assumed to be sequentially switched from the cursor function 1, cursor function 2, to cursor function 3. On the other hand, according to the rotation of the wheel in an upward direction (facing away from the user), the cursor function is assumed to be sequentially switched from the cursor function 3, cursor function 2, to cursor function 1. Then, as shown in FIG. 5A, it is assumed that in the case of the context A, cursor functions A, B, and C are assigned to the cursor functions 1 to 3, respectively. It is also assumed that in the case of the context B, the cursor functions A, D, E are assigned to the cursor functions 1 to 3, respectively. The number of the cursor functions may be changed according to the context.

(1) The rotating position of the wheel indicates a cursor function N, in which N is an integer ranging from one to three at a time when the processing operation has been started at step 501. First, the context of the cursor is checked at step 502.

(2) When it is found that the context of the cursor is the context A after the check at 502, the cursor functions 1, 2, and 3 are assigned to the cursor functions A, B, and C, respectively at step 503 according to cursor function assignment described with reference to FIG. 5A. When it is found that the context of the cursor is the context B, the cursor functions A, D, and E are assigned to the cursor functions 1, 2, and 3, respectively at step 504.

(3) After the processing at step 503 or 504, the cursor function N determined by the rotating position of the wheel at the start of the processing operation is selected at step 505, and a cursor N corresponding to the cursor function N is displayed at step 506. When the cursor function determined by the rotating position of the cursor at the start of the processing operation is the cursor function 1 (in which N is equal to one), for example, a cursor A is displayed in both of the contexts A and B. When the cursor function is the cursor function 2 (in which N is equal to 2), for example, a cursor B is displayed in the case of the context A, and a cursor D is displayed in the case of the context B.

(4) Next, it is checked at step 507 whether the wheel has been rotated or not. It is also checked in which direction the wheel has been rotated. When it is found that the wheel has been rotated in the downward direction, it is determined whether the integer N of the cursor function N determined by the rotating position of the wheel at the start of the processing operation is smaller than three or not at step 508. When it is found at step 508 that the integer N is smaller than three, the cursor function is sequentially switched from the cursor function 1, cursor function 2, to cursor function 3 at step 509. Alternatively, the cursor function is switched from the cursor function 2 to the cursor function 3 at step 509.

(5) When it is found after the check at step 507 that the wheel has been rotated in the upward direction, it is determined whether the integer N of the cursor function N determined by the rotating position of the wheel at the start of the processing operation is larger than one at step 510. When it is found at step 510 that the integer N is larger than one, the cursor function is sequentially switched from the cursor function 3, cursor function 2, to cursor function 1 at step 511. Alternatively, the cursor function is switched from the cursor function 2 to the cursor function 1 at step 511.

(6) When it is found after the determination at step 508 that the integer N of the cursor function N is three, when it is found after the determination at step 510 that the integer N of the cursor function N is one, or when it is found after the check at step 507 that the wheel has not been rotated, the cursor function N is kept unchanged from the cursor function N determined by the rotating position of the wheel at the start of the processing operation, at step 512.

Next, the cursor function N changed by the processing at step 509 or step 511, or kept unchanged by the processing at step 512 is selected at step 513, and the cursor N having the shape corresponding to the cursor function N is displayed at step 514. When the cursor function obtained by these processing is the cursor function 2 (in which N is equal to two), for example, the cursor B is displayed in the case of the context A, while the cursor D is displayed in the case of the context B. When the cursor function obtained by these processing is the cursor function 3 (in which N is equal to three), for example, the cursor C is displayed in the case of the context A, while the cursor E is displayed in the case of the context B.

(8) Next, it is determined whether the wheel or the left-clicking button has been pressed down or not at step 515. When it is found that the wheel or the left-clicking button has not been pressed down, the operation is returned to the processing at step 502 and the processing is repeated. When it is found that the wheel or the left-clicking button has been pressed down, the cursor function N is executed at step 516, the operation is returned to the processing at step 502, and the processing is repeated for a subsequent processing operation.

The alternative of step 507 will be described next.

Before checking whether the wheel has been rotated or not, it is checked at step 507 whether the right-clicking button has been pressed down or not.

When it is found that the right-clicking button has been pressed down, it is checked whether the wheel has been rotated or not.

And the process of after detecting rotation of the wheel is the same as foregoing description.

When it is found after the check at step 507 that the right-clicking button has not been pressed down, the cursor function N is kept unchanged from the cursor function N determined by the rotating position of the wheel at the start of the processing operation, at step 512 except checking the wheel.

In this case, the screen information can be scrolling by rotation of the wheel without pressing the right-clicking button.

The other alternative of step 507 will be described next.

Before checking whether the wheel has been rotated or not, it is checked at step 507 whether the right-clicking button has been pressed down or not.

When it is found that the right-clicking button has been pressed down, the cursor function N is kept unchanged from the cursor function N determined by the rotating position of the wheel at the start of the processing operation, at step 512 except checking the wheel.

When it is found after the check at step 507 that the right-clicking button has not been pressed down, it is checked whether the wheel has been rotated or not.

And the process of after detecting rotation of the wheel is the same as foregoing description.

In this case, the screen information can be scrolling by rotation of the wheel with pressing the right-clicking button.

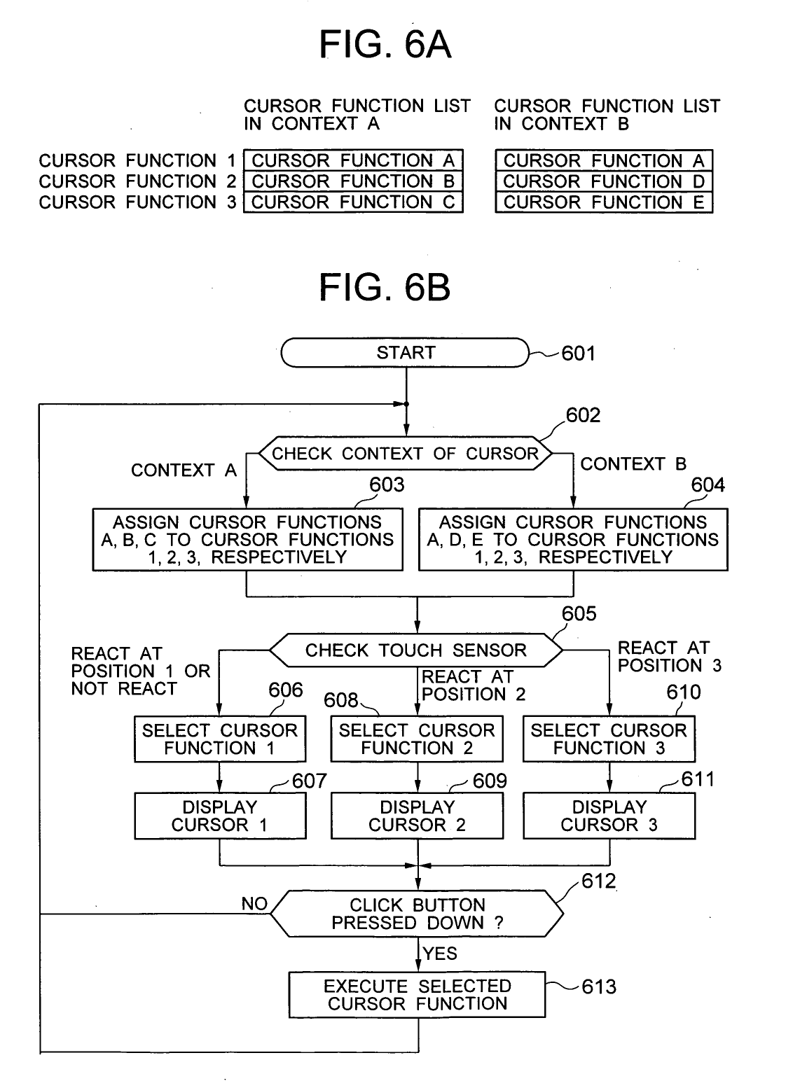

FIG. 6A is a diagram showing cursor function arrangement when the pointing device with touch sensor (hereinafter referred to just as the mouse) described with reference to FIGS. 4A, 4B, and 4C is employed.

FIG. 6B is a flowchart explaining a processing operation of the information processing device when the pointing device with touch sensor is employed. Next, the processing operation will be described.

As in the description given with reference to FIG. 5A, it is assumed that there are two types of the contexts A and B of the cursor in processing in FIG. 6B, as shown in FIG. 6A. It is also assumed that there are the three cursor functions 1 to 3 that can be selected according to the touched position of the touch sensor. It is further assumed that the cursor function 1 is assigned to the left side of the touch sensor, the cursor function 2 is assigned to the middle of the touch sensor, and the cursor function 3 is assigned to the right side of the touch sensor.

(1) The processing is started at step 601, and the context of the cursor is first checked at step 602.

(2) When it is found that the context of the cursor is the context A after the check at 602, the cursor functions 1, 2, and 3 are assigned to the cursor functions A, B, and C, respectively at step 603 according to the cursor function assignment described with reference to FIG. 5A. When it is found that the context of the cursor is the context B, the cursor functions A, D, and E are assigned to the cursor functions 1, 2, and 3, respectively at step 604.

(3) Next, it is checked whether the finger has touched the touch sensor or not at step 605. It is also checked in which location on the touch sensor the finger has touched. When a reaction in which the finger has touched the left side (a position 1) of the touch sensor is detected, or when it is found that the finger has not touched anywhere on the touch sensor, the cursor 1 is selected at step 606, and the cursor having the shape corresponding to the cursor function 1 is displayed at step 607. In this case, in both cases of the context A and the context B, the cursor A is displayed.

(4) When the reaction in which the finger has touched the middle (a position 2) of the touch sensor is detected after the check at step 605, the cursor function 2 is selected at step 608, and the cursor having the shape corresponding to the cursor function 2 is displayed at step 609. In this case, the cursor function B is displayed in the case of the context A, while the cursor D is displayed in the case of the context B.

(5) When the reaction in which the finger has touched the right side (a position 3) of the touch sensor is detected after the check at step 605, the cursor function 3 is selected at step 610, and the cursor having the shape corresponding to the cursor function 3 is displayed at step 611. In this case, the cursor function C is displayed in the case of the context A, while the cursor E is displayed in the case of the context B.

(6) Next, it is determined whether the left-clicking button has been pressed down together with the touch sensor or not at step 612. When it is found that the left-clicking button has not been pressed down, the operation is returned to the processing at step 602 and the processing is repeated. When it is found the left-clicking button has been pressed down together with the touch sensor, the cursor function displayed by the processing at step 607, 609, or 611 is executed at step 613, the operation is returned to the processing at step 602, and the processing is repeated for a subsequent processing operation.

The processing operation of the information processing device when the pointing device with touch sensor described with reference to FIG. 6 is operated is the same as the processing when the pointing device with slider switch described with reference to FIGS. 3A, 3B, and 3C is operated.

Each of the processing in this embodiment of the present invention described above can be constituted as a processing program. This processing program can be stored in a recording medium such as an a hard disk (HD), a digital audio tape (DAT), a floppy disk (FD), a magneto-optic disk (MO), a digital video disc-read only memory (DVD-ROM), or a compact disc read only memory (CD-ROM), for supply.

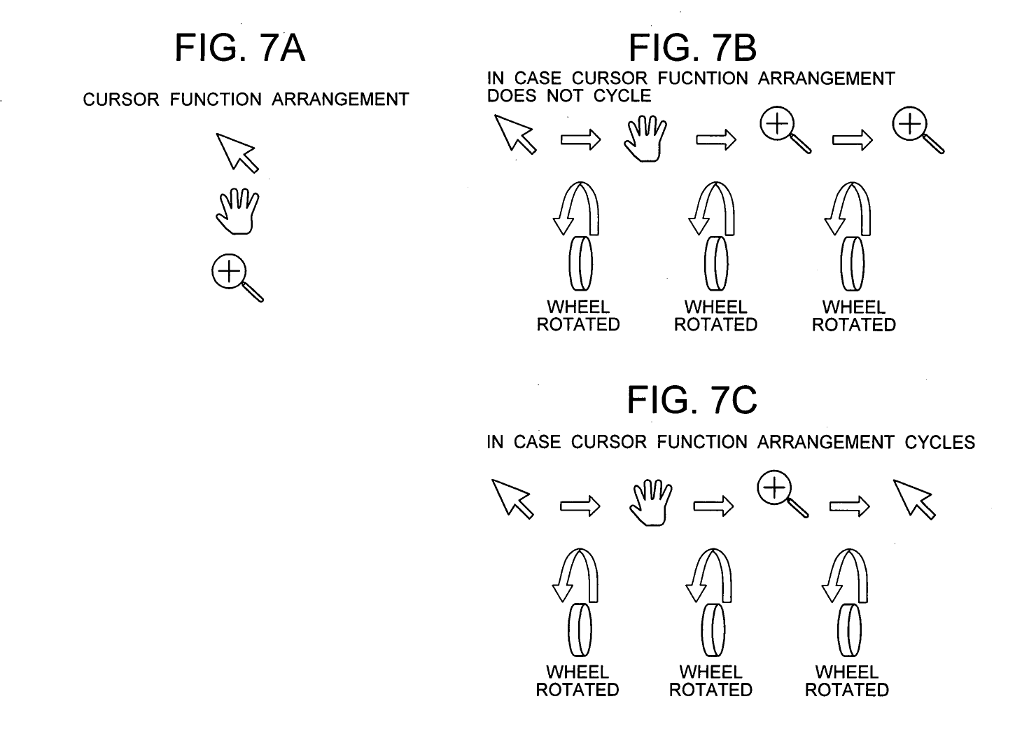

FIGS. 7A, 7B, and 7C are diagrams specifically explaining changes in the cursor function in the processing when the pointing device with wheel described with reference to FIGS. 5A and 5B is operated. Next, the changes in the cursor function will be described.

Now, it is assumed that as shown in FIG. 7A, the cursor functions 1 to 3 are a selecting function displayed by an arrow, a scrolling function indicated by a hand, and a zooming function indicated by a plus mark, respectively, as seen from top to bottom of FIG. 7A. When the wheel is rotated in the downward direction as shown in FIG. 7B in the processing described in the flowchart shown in FIG. 5B, the cursor function is sequentially changed from the selecting function indicated by the arrow to the scrolling function displayed by the hand, and then to the zooming function indicated by the plus mark, for example, as shown in FIG. 7B. After the cursor has become the cursor showing the zooming function indicated by the plus mark, the cursor remains unchanged from the cursor showing the zooming function indicated by the plus mark even if the wheel is further rotated in the downward direction. This also holds true when the wheel is rotated in the upward direction: after the cursor has become the cursor showing the selecting function indicated by the arrow, the cursor remains unchanged from the cursor showing the selecting function indicated by the arrow even if the wheel is further rotated in the upward direction.

Assume that such a relationship between the cursor functions and the rotation of the wheel is set and a specific cursor function is arranged at the beginning or last of a cursor function candidate list. Then, the predetermined specific cursor function arranged at the beginning or last of the cursor function candidate list can be readily selected by rotation of the wheel completely.

In an example shown in FIG. 7C, the three cursor functions are cycled. More specifically, when the wheel is rotated in the downward direction as shown in FIG. 7C, the cursor function is sequentially changed from the selecting function indicated by the arrow to the scrolling function indicated by the hand, and to the zooming function indicated by the plus mark. Then, when the wheel is further rotated in the downward direction, the cursor function is returned again to the selecting function indicated by the arrow. Then, the cursor function is sequentially changed to the scrolling function indicated by the hand, and then to the zooming function indicated by the plus mark. When the wheel is rotated in the upward direction, the cursor function is cyclically changed in an order reverse to the order of the cursor function change described above when the wheel is rotated in the downward direction.

The foregoing description was directed to the cursor function switching method in the embodiment of the present invention. Next, an application example of the cursor function switching method in the embodiment of the present invention, described above, will be described.

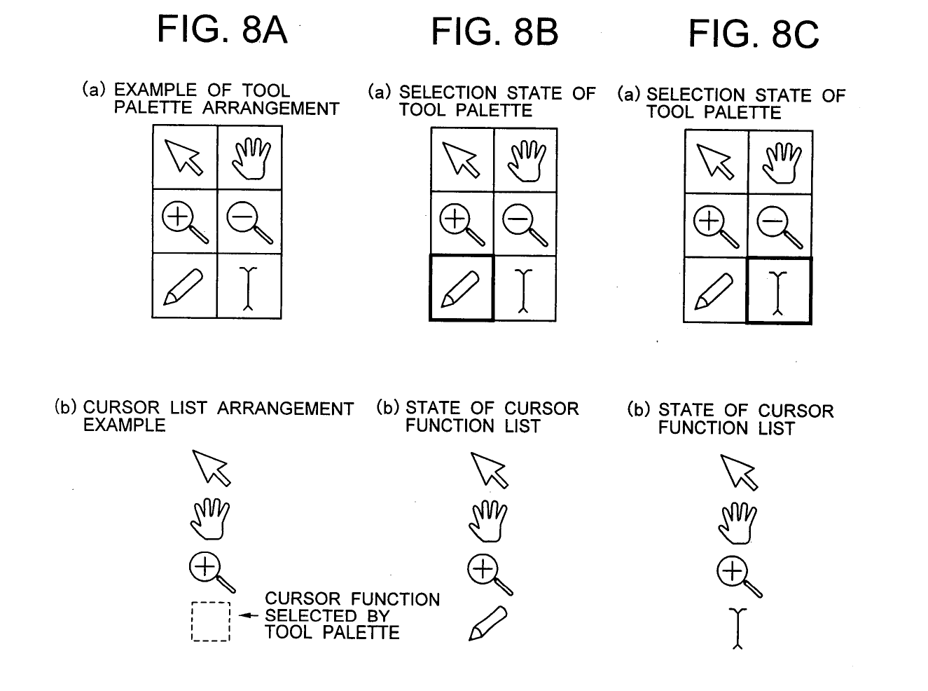

FIGS. 8A, 8B, and 8C are diagrams explaining an application example when the cursor switching method in this embodiment of the present invention is used in conjunction with a tool palette. Next, this application example will be described. In the application example shown in FIGS. 8A, 8B, and 8C, four types of cursor functions can be switched according to the cursor function switching method described before.

Generally, the tool palette enables improvement in usability when drawing software or the like is used. One of a plurality of cursor functions as shown in (a) of FIG. 8A, for example, can be selected. Then, by using the selected cursor function, the drawing software can be efficiently utilized. In the application example which will be described herein, as shown in (b) of FIG. 8A, three of the four cursor functions that can be used for cursor function switching in the embodiment of the present invention are assigned to the selecting function displayed by the arrow, the scrolling function displayed by the hand, and the zooming function displayed by the plus mark, all of which were described in FIGS. 7A to 7C as well. Then, the remaining one of the four cursor functions is assigned to a cursor function selected from the tool palette, and used.

The user first clicks one of cursors in the tool palette, thereby positioning an arbitrary one of the cursors with cursor functions assigned in the embodiment of the present invention in advance to the cursor of the tool palette the user desires to use. The arbitrary one of the cursor functions is positioned to the cursor with a coloring function displayed in (a) of FIG. 8B as a pencil, for example. This displays the frame line of a region in which this cursor function is displayed to be thick, so that selection of the cursor with the coloring function is indicated. Then, when the user presses down the left-clicking button in the embodiment of the present invention described above, the cursor with the coloring function selected from the tool palette is captured as the cursor to be used by switching in the embodiment of the present invention, as shown in (b) of FIG. 8B.

This enables the user to use the cursor function selected from the tool palette by switching according to the processing in the embodiment of the present invention. An example in FIG. 8C shows the example in which the cursor with a text editing function has been selected and captured. As in the case described with reference to FIG. 8B, the cursor with the text editing function can be captured.

In the foregoing description, it was described that the cursor function selected from the tool palette is added to the cursor functions that have been assigned in the embodiment of the present invention in advance. When the number of the types of the cursors to be selected in the embodiment of the present invention described above is small, the cursor function less frequently used among the assigned cursor functions can be replaced by the cursor function selected from the tool palette. In this case, one of the cursors less frequently used among the assigned cursors should be positioned to the cursor in the tool palette desired to be used, and the left-clicking button should be pressed down.

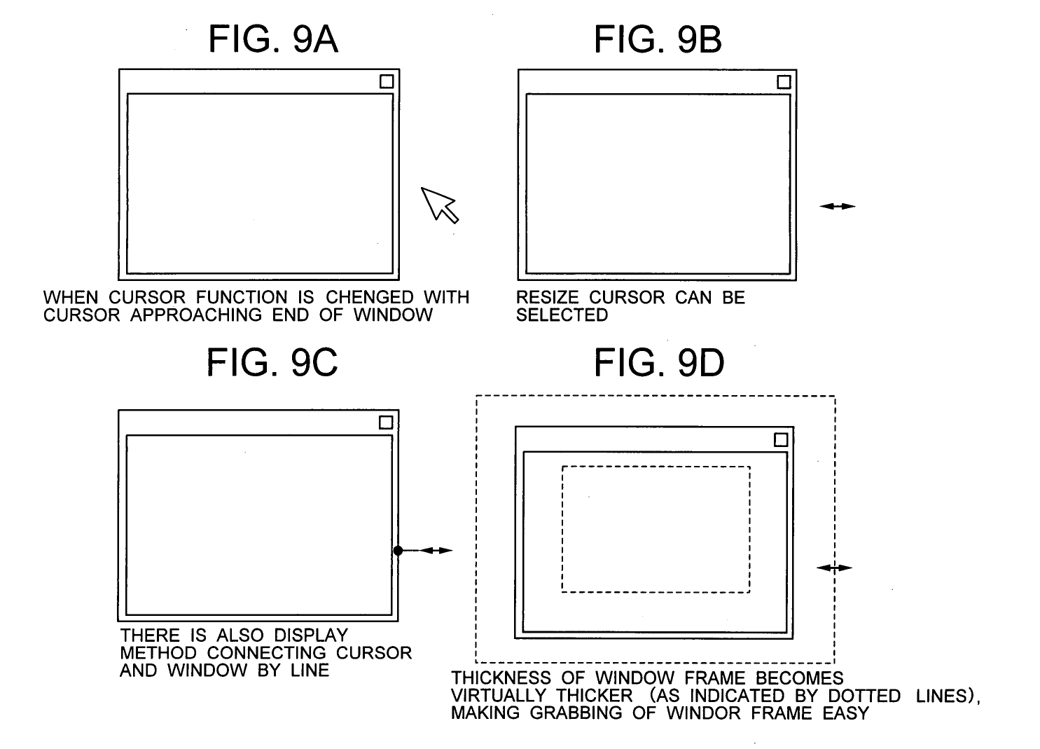

FIGS. 9A to 9D are diagrams explaining an application example in which the embodiment of the present invention is used for expansion of a hit area. Next, this application example will be described. The application example described herein is effective when the hit area of the cursor is expanded and the area of a window within the display screen is expanded or reduced, for example. In each of FIGS. 9A to 9D, the frame line of the window shown is shown in an outermost side, and the area of a text and a button within the window are inside the frame line of the window.

Generally, when the area of the window within the display screen is expanded or reduced, it is necessary to operate the cursor to be positioned on the frame line of the window. In the application example described herein, when the cursor approaches the frame line of the window (within a distance from the predetermined frame line), it is arranged that the cursor can be functioned as in a case where the cursor is positioned on the frame line of the window.

For this reason, in the application example shown in FIGS. 9A to 9D, when the cursor approaches the frame line of the window, the context of the cursor is checked, thereby assigning the cursor function for resizing. Then, when an operation for cursor selection in the embodiment of the present invention, or when the wheel is rotated, for example, in a state where the cursor is close to the frame line of the window as shown in FIG. 9A, a resize cursor with the resize function as the cursor function can be selected, as shown in FIG. 9B. When the left-clicking button is pressed down in this state, the frame line of the window is moved to the position of the resize cursor. Then, when the cursor is dragged, the frame line of the window can be moved to an arbitrary position as in the case of an operation commonly performed.

When the resize cursor is selected, a line connecting the frame line to be moved and the resize cursor can be displayed, as shown in FIG. 9C, and the frame line to be moved can also be clearly displayed to the user.

FIG. 9D shows a range in which the cursor function for resizing is assigned by checking the context of the cursor. When the cursor is located in a region within squares indicated by dotted lines, the context of the cursor is checked so as to enable movement of the frame line within this region, and the cursor function for resizing is assigned. With this arrangement, the thickness of the frame line of the window virtually becomes thick, so that the frame line can be easily grabbed.

In the foregoing description, the cursor function switching method and its applications in the embodiment of the present invention were described. When cursor function switching is performed in the embodiment of the present invention described above, it was not seen that what cursors with what function can be selected as a whole unless an operation for selection was performed. In the present invention, when the context is determined to perform cursor selection, the shapes of all the cursor functions that can be selected can be displayed, and it can be informed to the user that what cursors with what functions can be selected.

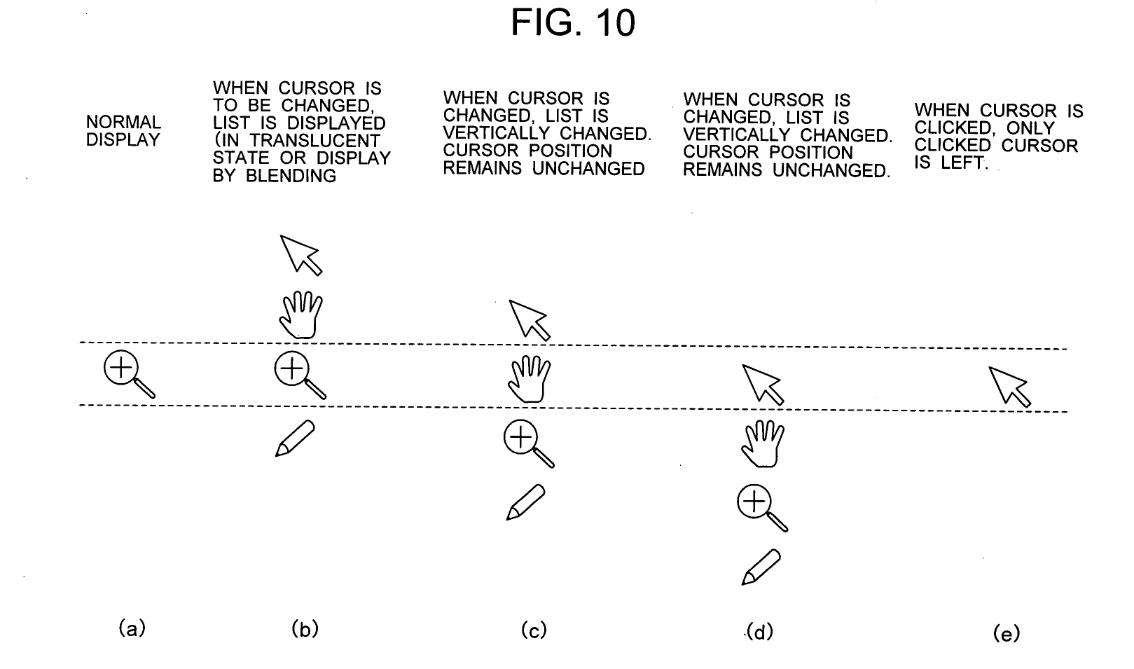

FIG. 10 is diagram explaining display of cursor alternatives, which will be described next.

Normally, as shown in (a) of FIG. 10, the cursor of a shape with the cursor function selected currently is displayed. Herein the cursor with the zooming function is displayed. When the user is to touch the wheel of the pointing device and rotate the wheel, for example, so as to switch the cursor function, a list of the cursors of shapes with the cursor functions that can be switched according to the rotation of the wheel is displayed above and below the cursor with the zooming function displayed to be selectable, as shown in (b) of FIG. 10. In this case, the cursors of the shapes with the switchable cursor functions that are displayed above and below the cursor function with the zooming function are displayed in a semi-transparent state or by blending to show that those cursors are selectable.

When the user rotates the wheel in this state so as to switch the cursor function, the whole list of the cursors are shifted up and down and displayed, as shown in (c) and (d) of FIG. 10. Display of the cursors that could be selected by the rotation of the wheel becomes a normal display from the display in the semi-transparent state or the display by blending, without changing their positions. Then, when clicking is performed in a state shown in (d) of FIG. 10, for example, the cursor that is currently selectable, or the cursor of the arrow shape with the selecting function is selected. Display of other cursors is then erased. In the embodiment of the present invention, it can also be so arranged that when a certain time has passed after stopping of the rotation of the wheel, the other cursors may be erased.

According to an example described above, when cursor function switching is performed, the user can see what cursors with what functions can be selected as a whole at a glance.

Other example of a case where the present invention has been applied to the command selection will be described next.

When the user is to touch the wheel of the pointing device and rotate the wheel, a list of the command menu that can be selected according to the rotation of the wheel is displayed above and below the cursor.

And the operation and behavior of the menu are the same as the list of the cursors of shapes described above.

And it depends on the context, for example, the location of the cursor or the timing of the rotation of the wheel, whether the list of the command menu is displayed or the list of the cursors of shapes is displayed.

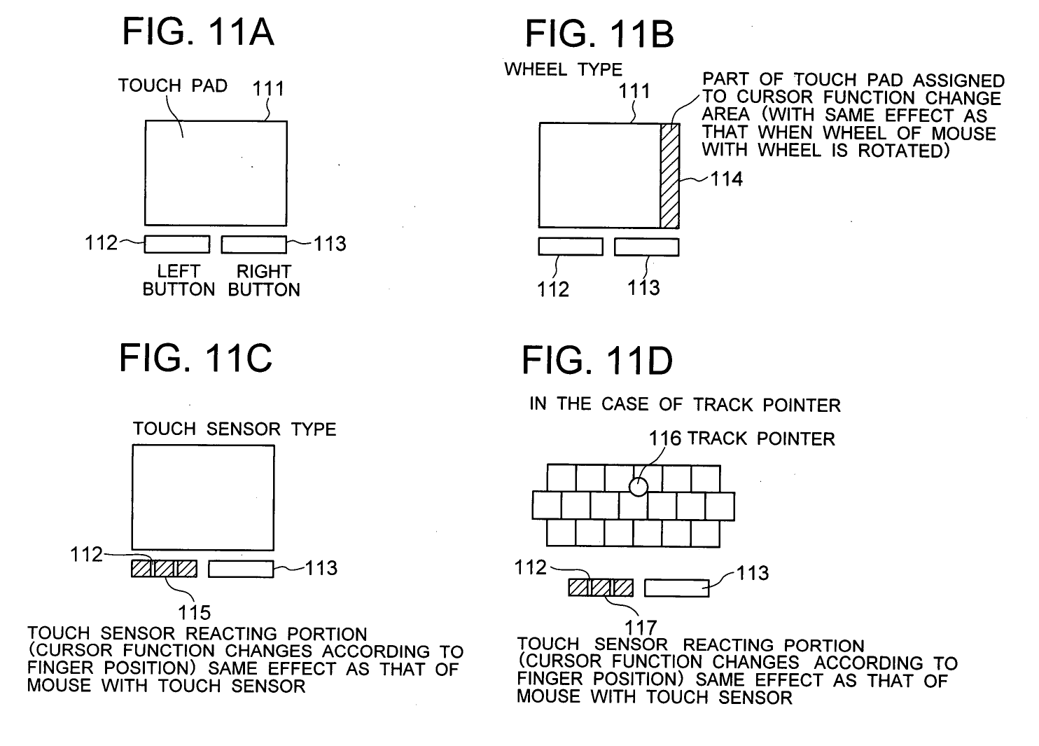

FIGS. 11A to 11D are diagrams explaining an example of a case where the present invention has been applied to the pointing device of a notebook PC. Next, this example will be described. Referring to FIGS. 11A to 11D, the notebook PC is constituted from a touch pad 111, a left-clicking button 112, a right-clicking button 113, a wheel function unit 114, touch sensors 115 and 117, and a track pointer 116.

Various examples when the mouse is employed as the pointing device used in the above-mentioned cursor function switching method in the embodiment of the present invention were described. The present invention can also be used for the pointing device such as the touch pad or track pointer used a lot in the notebook PC or the like. Next, an example of application to the notebook PC will be described.

As the pointing device used a lot in the notebook PC or the like, the touch pad as shown in FIG. 11A may be employed. The pointing device using this touch pad is constituted from the touch pad 111 provided outside the key arrangement region of a keyboard, the left-clicking button 112, and the right-clicking button 113. By touching the finger on the touch pad 111 and moving the finger by the user, movement of the cursor can be controlled. Then, functions of the left-clicking button 112 and the right-clicking button 113 are the same as those of the mouse.

One of examples where the present invention has been applied to the pointing device that uses the touch pad as described above is shown in FIG. 11B. The wheel function unit 114 is provided in part of the region of the touch pad 111. This wheel function unit 114 is provided in a rectangular shape along the right end or left end of the touch pad 111. By touching the finger on the wheel function unit 114 and moving the finger back and forth by the user, a function comparable to the function of the wheel 23 of the mouse with wheel, described with reference to FIGS. 2A, 2B, and 2C can be performed. In such an example as well, cursor function switching can be performed as in the case described in FIGS. 2A, 2B, and 2C. In this example, the wheel function unit 114 may be provided in the lower end or upper end of the touch pad, and the user may touch the finger on the wheel function unit 114 and may move the finger to the right or left. Alternatively, the wheel function unit 114 can be used as the touch sensor, and according to the position touched by the finger, the cursor function can also be selected.

Other example in which the present invention has been applied to the pointing device that uses the touch pad as described above is shown in FIG. 11C. The touch sensor 115 is provided on the left-clicking button 112. The touch sensor 115 provided on this left-clicking button 112 can perform a function comparable to the function of the touch sensor 41 of the mouse with touch sensor, described with reference to FIGS. 4A, 4B, and 4C. In such an example as well, cursor function switching can be performed as in the case described with reference to FIGS. 4A, 4B, and 4C.

Alternatively, as the pointing device used a lot in the notebook PC or the like, the track pointer as shown in FIG. 11D may be employed. The pointing device using this track pointer is constituted from the track pointer 116 provided within the key arrangement region of the keyboard, left-clicking button 112, and right-clicking button 113. By mounting the finger on the track pointer 116 and applying a force in a forward, backward, right, or left direction, movement of the cursor can be controlled. The functions of the left-clicking button 112 and the right-clicking button 113 are the same as those of the mouse. In this example, the touch sensor 117 is provided on the left-clicking button 112, as in a case in FIG. 1C. The touch sensor 117 provided on this left-clicking button 112 can perform the function comparable to the function of the touch sensor 41 of the mouse with touch sensor, described with reference to FIGS. 4A, 4B, and 4C. With such an example as well, cursor function switching can be performed as in the case described with reference to FIGS. 4A, 4B, and 4C.

It should be further understood by those skilled in the art that although the foregoing description has been made on embodiments of the invention, the invention is not limited thereto and various changes and modifications may be made without departing from the spirit of the invention and the scope of the appended claims.

1. A cursor function switching method in an information processing device, the information processing device displaying on a display screen thereof a cursor to be controlled by a pointing device, thereby performing operation processing, wherein
the information processing device includes a touch sensor for detecting a touched position on a touch surface on a click button of the pointing device; and
upon detection of clicking of the click button, a function assigned in advance to the touched position detected by the touch sensor is executed.

2. A cursor function switching method in an information processing device, the information processing device displaying on a display screen thereof a cursor to be controlled by a pointing device, thereby performing operation processing, wherein
the information processing device includes a plurality of touch sensors on a touch surface on a click button of the pointing device; and
upon detection of clicking of the click button, a function assigned in advance to one of the touch sensors that has detected a touch is executed.

3. The cursor function switching method according to claim 1, wherein upon detection of a touch by the touch sensor, a shape of the displayed cursor is changed to a shape indicating the function assigned in advance to the touched position detected by the touch sensor, for display.

4. The cursor function switching method according to claim 2, wherein upon detection of the touch by the touch sensor, a shape of the displayed cursor is changed to a shape indicating the function assigned in advance to said one of the touch sensors that has detected the touch, for display.

5. A cursor function switching method in an information processing device, the information processing device displaying on a display screen thereof a cursor to be controlled by a pointing device, thereby performing operation processing, wherein
upon receipt of a signal from cursor function selecting means of the pointing device, the information processing device assigns to the cursor a cursor function corresponding to the received signal and changes the displayed shape of the cursor to a shape indicating the assigned cursor function.

6. The cursor function switching method according to claim 5, wherein the cursor function selecting means transmits to the information processing device the signal indicating a rotated position of a wheel provided for the pointing device of a mouse type.

7. The cursor function switching method according to claim 5, wherein the cursor function selecting means transmits to the information processing device the signal indicating a touched position or a moved amount of a touch sensor provided for the pointing device of a mouse type.

8. The cursor function switching method according to claim 5, wherein the cursor function selecting means transmits to the information processing device the signal indicating a touched position or a moved amount of a touch sensor provided for the pointing device of a touch pad type.

9. The cursor function switching method according to claim 5, wherein the cursor function comprises a plurality of cursor functions and a number and types of the cursor functions that can be selected are changed according to a context of the cursor.

10. The cursor function switching method according to claim 6, wherein the cursor function comprises a plurality of cursor functions and a number and types of the cursor functions that can be selected are changed according to a context of the cursor.

11. The cursor function switching method according to claim 7, wherein the cursor function comprises a plurality of cursor functions and a number and types of the cursor function that can be selected are changed according to a context of the cursor.

12. The cursor function switching method according to claim 8, wherein the cursor function comprises a plurality of cursor functions and a number and types of the cursor functions that can be selected are changed according to a context of the cursor.
